(19) United States
(12) Patent Application Publication
(10) Pub. No.: US 2025/0000026 A1
(43) Pub. Date: Jan. 2, 2025

(54) ACTIVE CLEANING SYSTEM FOR A COTTON PICKER

(71) Applicants: CNH Industrial Canada, Ltd., Saskatoon (CA); CNH Industrial America LLC, New Holland, PA (US)

(72) Inventors: Martin J. Roberge, Quebec (CA); Jonathan E. Ricketts, Coal Valley, IL (US)

(21) Appl. No.: 18/756,765

(22) Filed: Jun. 27, 2024

Related U.S. Application Data
(60) Provisional application No. 63/510,685, filed on Jun. 28, 2023.

(51) Int. Cl. A01D 46/08

(52) U.S. Cl. CPC A01D 46/08

(57) ABSTRACT

A cleaning system for a cotton picker includes a cleaning air source having an outlet configured to be disposed within an inlet region of an accumulator of the cotton picker. The outlet of the cleaning air source is configured to be directed toward a grate of the accumulator, the inlet region of the accumulator is configured to receive agricultural material from a header of the cotton picker via a conveying air flow provided by a conveying air source, and the grate is configured to block passage of the agricultural material and to enable passage of debris.

### BACKGROUND

The present disclosure relates generally to a cleaning system for a cotton picker.

A cotton picker is used to harvest agricultural material (e.g., cotton) within a field. The cotton picker may include a header having drums configured to harvest the agricultural material from the field. The cotton picker may also include an air-assisted conveying system configured to move the agricultural material from the drums to an accumulator. From the accumulator, the agricultural material may be fed into a baler (e.g., via belt(s)). The baler may compress the agricultural material into a package to facilitate storage, transport, and handling of the agricultural material. For example, a round baler may compress the agricultural material into a round bale within a baling chamber, such that the round bale has a desired size and density. After forming the bale, the bale may be wrapped with a bale wrap to secure the agricultural material (e.g., cotton) within the bale and to generally maintain the shape of the bale.

The agricultural material harvested by the header may be mixed with debris (e.g., leaves, stems, small rocks, dirt, etc.). Accordingly, the air-assisted conveying system may move a combination of the agricultural material and debris from the drums to an inlet region of the accumulator. To facilitate debris removal, the accumulator may include a grate positioned at an upper portion of the accumulator. The grate is configured to block passage of the agricultural material (e.g., cotton) and to enable passage of the debris. Accordingly, as the agricultural material and the debris are moved to the inlet region of the accumulator by the air-assisted conveying system, the agricultural material may be reflected by the grate to a storage region of the accumulator, and the debris may pass through the grate, thereby exiting the accumulator. Unfortunately, while the cotton picker is operating in certain fields and/or under certain operating conditions, a significant amount of debris may remain mixed with the agricultural material (e.g., cotton) that is collected within the storage region of the accumulator, thereby reducing the quality/grade of the agricultural material within the resultant bale.

### BRIEF DESCRIPTION

In certain embodiments, a cleaning system for a cotton picker includes a cleaning air source having an outlet configured to be disposed within an inlet region of an accumulator of the cotton picker. The outlet of the cleaning air source is configured to be directed toward a grate of the accumulator, the inlet region of the accumulator is configured to receive agricultural material from a header of the cotton picker via a conveying air flow provided by a conveying air source, and the grate is configured to block passage of the agricultural material and to enable passage of debris.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a cotton picker having a cleaning system;

FIG. 2 is a schematic view of an embodiment of a cleaning system that may be employed within the cotton picker of FIG. 1;

FIG. 3 is a schematic view of another embodiment of a cleaning system that may be employed within the cotton picker of FIG. 1;

FIG. 4 is a flow diagram of an embodiment of a method for cleaning agricultural material within an accumulator of a cotton picker;

FIG. 5 is a schematic view of an embodiment of a control system that may be employed within the cotton picker of FIG. 1;

FIG. 6 is a schematic view of an embodiment of a conveying system that may be employed within the cotton picker of FIG. 1; and

FIG. 7 is a perspective view of an embodiment of a conveying system that may be employed within the cotton picker of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

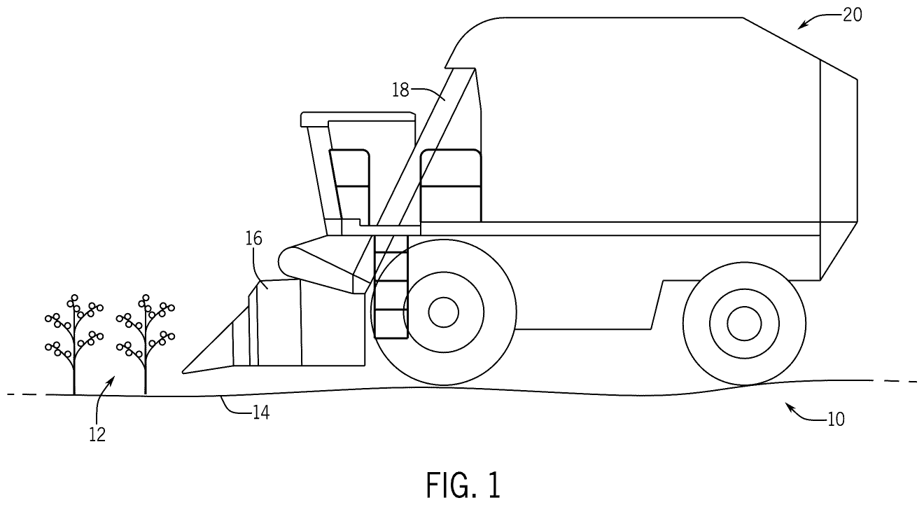

FIG. 1 is a side view of an embodiment of a cotton picker 10 having a cleaning system. The cotton picker 10 is configured to harvest agricultural material 12 (e.g., cotton) from a field 14 and to form the agricultural material 12 into bales (e.g., round bales, square bales, etc.). In the illustrated embodiment, the cotton picker 10 includes a header 16 having drums configured to harvest the agricultural material 12 from the field 14. Additionally, the cotton picker 10 includes an air-assisted conveying system 18 configured to move the agricultural material 12 from the drums of the header 16 to an accumulator. The agricultural material 12 may then be fed into a baler 20, such as via belt(s). The baler 20 is supported by and/or mounted within or on a chassis of the cotton picker 10. The baler 20 may form the agricultural material 12 into round bales, square bales, or bales of another suitable shape. After forming the agricultural material 12 into a bale, a bale wrapping system of the cotton picker 10 may wrap the bale with a bale wrap to secure the agricultural material 12 (e.g., cotton) within the bale and to generally maintain a shape of the bale.

The agricultural material harvested by the header 16 may be mixed with debris (e.g., leaves, stems, small rocks, dirt, etc.). The air-assisted conveying system 18 may move a combination of the agricultural material and debris from the drums to an inlet region of the accumulator via a conveying air flow provided by a conveying air source of the air-assisted conveying system 18. To facilitate debris removal, the accumulator includes a grate positioned at an upper portion of the accumulator. The grate is configured to block passage of the agricultural material (e.g., cotton) and to enable passage of the debris. Accordingly, as the conveying air flow moves the agricultural material and the debris through the inlet region of the accumulator, the agricultural material may be reflected by the grate to a storage region of the accumulator, and the debris may pass through the grate, thereby exiting the accumulator.

As discussed in detail below, to enhance the cleanliness of the agricultural material, the cotton picker 10 includes a cleaning system having a cleaning air source. The cleaning air source has an outlet disposed within the inlet region of the accumulator, and the outlet of the cleaning air source is directed toward the grate of the accumulator. The cleaning air output through the outlet of the cleaning air source increases the amount of agricultural material and the debris directed toward the grate and/or increases the speed of the agricultural material and the debris in a direction toward the grate. As a result, the amount of debris mixed with the agricultural material may be reduced, thereby enhancing the quality/grade of the agricultural material within the resultant bale. For example, while the cotton picker is operating in certain fields and/or under certain operating conditions, the conveying air flow may be insufficient to remove a desired amount of debris from the agricultural material. Accordingly, while the cotton picker is operating in such fields and/or under such operating conditions, the cleaning air source may be activated to remove the desired amount of debris. However, while the conveying air flow is sufficient to remove the desired amount of debris from the agricultural material, operation of the cleaning air source may be terminated to reduce energy consumption.

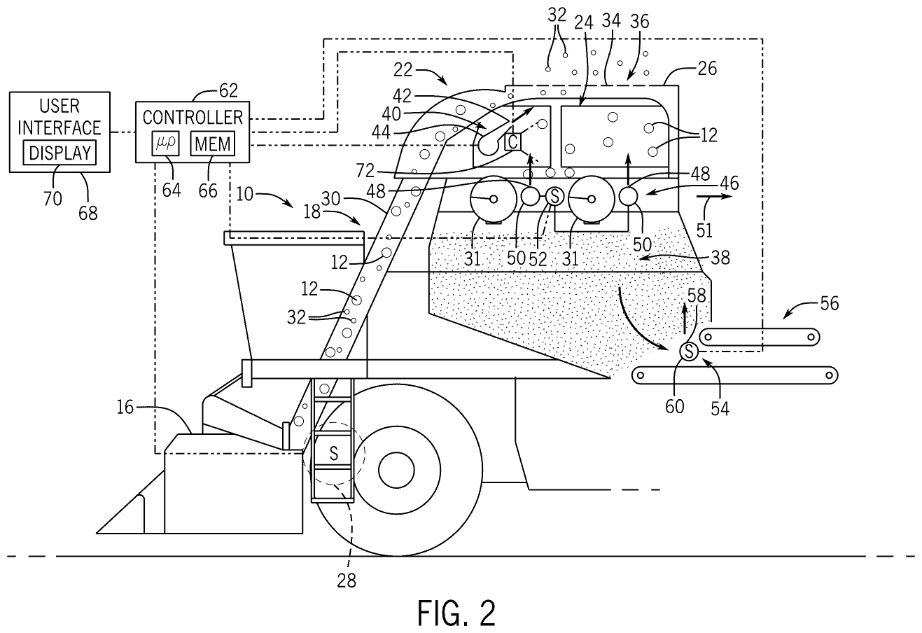

FIG. 2 is a schematic view of an embodiment of a cleaning system 22 (e.g., active cleaning system) that may be employed within the cotton picker of FIG. 1. As previously discussed, the header 16 of the cotton picker 10 includes drums configured to harvest agricultural material 12 (e.g., cotton) from a field. Furthermore, the air-assisted conveying system 18 is configured to move the agricultural material 12 from the drums of the header 16 to an inlet region 24 of the accumulator 26. In the illustrated embodiment, the air-assisted conveying system 18 includes a conveying air source 28 configured to output a conveying air flow through one or more ducts 30. Each duct 30 receives the agricultural material 12 (e.g., cotton) from the header 16, and the conveying air flow output by the conveying air source 28 drives the agricultural material to move through the duct(s) 30 from the header 16 to the inlet region 24 of the accumulator 26. In the illustrated embodiment, the cotton picker 10 includes augers 31 configured to distribute the agricultural material 12 (e.g., cotton) along a direction crosswise to the direction of movement of the agricultural material 12 from the duct(s) 30 to the accumulator 26. In the illustrated embodiment, the cotton picker 10 includes two augers 31. However, in other embodiments, the cotton picker may include more or fewer augers (e.g., 0, 1, 3, 4, or more). As previously discussed, the agricultural material 12 may be mixed with debris 32 (e.g., leaves, stems, small rocks, dirt, etc.). Accordingly, the conveying air flow drives the mixture of agricultural material 12 and debris 32 from the header 16, through the duct(s) 30, and to the inlet region 24 of the accumulator 26.

In the illustrated embodiment, the accumulator 26 includes a grate 34 positioned at an upper portion 36 of the accumulator 26. The grate 34 is configured to block passage of the agricultural material 12 and to enable passage of the debris 32. Accordingly, as the conveying air flow moves the agricultural material 12 and the debris 32 through the inlet region 24 of the accumulator 26, the agricultural material 12 may be reflected by the grate 34 to a storage region 38 of the accumulator 26, and the debris 32 may pass through the grate 34, thereby exiting the accumulator 26. The grate 34 may include any suitable structure(s) configured to block passage of the agricultural material 12 and to enable passage of the debris 32. For example, the grate may include one or more bars spaced apart from one another by a distance suitable for blocking passage of the agricultural material and enabling passage of the debris. Additionally or alternatively, the grate may include a screen having openings that enable passage of the debris through the openings while blocking passage of the agricultural material.

In the illustrated embodiment, the cleaning system 22 includes a first cleaning air source (e.g., cleaning air source) 40. The first cleaning air source 40 has an outlet 42 disposed within the inlet region 24 of the accumulator 26. The outlet 42 of the first cleaning air source 40 is separate/distinct from the outlet(s) of the duct(s) 30 of the air-assisted conveying system 18. In addition, the outlet 42 of the first cleaning air source 40 is directed toward the grate 34 of the accumulator 26. Accordingly, the first cleaning air source 40 is configured to output first cleaning air (e.g., cleaning air) toward the agricultural material 12 and the debris 32 within the inlet region 24 of the accumulator 26, thereby driving the agricultural material 12 and the debris 32 toward the grate 34. As a result, the amount of agricultural material 12 and debris 32 directed toward the grate 34 may be increased, as compared to the amount of agricultural material 12 and debris 32 directed toward the grate by the conveying air flow alone. Additionally or alternatively, the speed of the agricultural material 12 and the debris 32 in a direction toward the grate 34 may be increased, as compared to the speed of the agricultural material 12 and the debris 32 in the direction toward the grate 34 caused by the conveying air flow alone. Accordingly, the amount of debris mixed with the agricultural material may be reduced, thereby enhancing the quality/grade of the agricultural material within the resultant balc.

In the illustrated embodiment, the first cleaning air source 40 includes an air output device 44 disposed within the inlet region 24 of the accumulator 26. The air output device 44 may be mounted to the structure of the accumulator 26 via any suitable type(s) of mount(s) (e.g., strut(s), rod(s), cable(s), etc.). Furthermore, the air output device 44 may include a fan, an air compressor, or another suitable type of air output device. The air output device 44 (e.g., fan, air compressor, etc.) may be driven by any suitable type(s) of drive(s), such as pneumatic motor(s), electric motor(s), hydraulic motor(s), etc. In addition, the outlet 42 of the first cleaning air source 40 may have any suitable extent along a direction crosswise to the direction of movement of the agricultural material 12 and the debris 32 toward the grate 34. While the first cleaning air source 40 includes a single outlet 42 and a single air output device 44 in the illustrated embodiment, in other embodiments, the first cleaning air source may include additional air output device(s) (e.g., 1, 2, 3, 4, or more additional air output devices) and/or additional outlet(s) (e.g., 1, 2, 3, 4, or more additional outlets). For example, the first cleaning air source may include multiple outlets distributed along the direction crosswise to the direction of movement of the agricultural material 12 and the debris 32 toward the grate 34. In addition, while the air output device 44 is disposed within the inlet region 24 of the accumulator 26 in the illustrated embodiment, in other embodiments, the air output device may be disposed within/at another suitable location (e.g., within the storage region of the accumulator, on the chassis of the cotton picker, etc.).

In certain embodiments, the first cleaning air source 40 is configured to output a continuous flow of the first cleaning air. Accordingly, the first cleaning air may continuously drive the agricultural material 12 and the debris 32 to move toward the grate 34. However, in certain embodiments, the first cleaning air source may be configured to output the first cleaning air as pulses (e.g., at a high frequency, at a high duty cycle, etc.) to drive the agricultural material and the debris to move toward the grate.

In the illustrated embodiment, the cleaning system 22 includes a second cleaning air source 46 having one or more outlets 48 disposed within the inlet region 24 of the accumulator 26. As illustrated, the outlet(s) 48 of the second cleaning air source 46 are directed toward the agricultural material 12 and the debris 32 within the inlet region 24 of the accumulator 26. In addition, the outlet(s) 48 of the second cleaning air source 46 are configured to output a flow of second cleaning air (e.g., cleaning air flow) to induce turbulent movement of the agricultural material 12 and the debris 32. The turbulent movement of the agricultural material 12 and the debris 32 may drive the debris 32 to separate from the agricultural material 12 (e.g., removing debris from fibers of the cotton), thereby enabling the conveying air flow and the flow of the first cleaning air to drive the agricultural material 12 and the debris 32 toward the grate 34, which reflects the agricultural material 12 toward the storage region 38 and enables the debris 32 to pass through the grate 34 to the environment. As a result, the effectiveness of the cleaning system 22 in removing the debris 32 from the agricultural material 12 may be enhanced.

In the illustrated embodiment, the second cleaning air source 46 includes two tubes 50 that extend through the inlet region 24 of the accumulator 26, and the tubes 50 include the outlets 48. Furthermore, in the illustrated embodiment, the tubes 50 extend along a direction crosswise to the direction of movement of the agricultural material 12 and the debris 32 toward the grate 34. Each tube 50 may include multiple outlets 48 distributed along the direction crosswise to the direction of movement of the agricultural material 12 and the debris 32 toward the grate 34. For example, in certain embodiments, at least one tube 50 may include 1, 2, 3, 4, 5, 6, 7, 8, 9, 10, or more outlets 48. In the illustrated embodiment, one tube 50 is positioned between the augers 31 with respect to a longitudinal axis 51 of the cotton picker, and another tube 50 is positioned on an opposite side of the augers 31 from the duct(s) 30 with respect to the longitudinal axis 51. In addition, each tube 50 is positioned at about the same vertical position as the augers 31. However, in other embodiments, the tubes may be positioned in other suitable locations relative to the augers. For example, in certain embodiments, both tubes may be positioned between the augers with respect to the longitudinal axis, or at least one tube may be positioned on the same side of the augers as the duct(s) with respect to the longitudinal axis. Furthermore, in certain embodiments, at least one tube may be positioned above or below the augers. For example, in certain embodiments, each tube may be positioned below a respective auger and aligned with the respective auger with respect to the longitudinal axis. While the tubes 50 extend along the direction crosswise to the direction of movement of the agricultural material 12 and the debris 32 toward the grate 34 in the illustrated embodiment, in other embodiments, at least one tube may extend along another suitable direction. Furthermore, while each tube 50 is substantially straight in the illustrated embodiment, in other embodiments, at least one tube may have another suitable shape (e.g., bent, curved, circular, etc.). While the second cleaning air source 46 has two tubes 50 in the illustrated embodiment, in other embodiments, the second cleaning air source may have more or fewer tubes (e.g., 1, 2, 3, 4, 5, 6, or more). In addition, while the second cleaning air source 46 includes tube(s) 50 in the illustrated embodiment, in other embodiments, the second cleaning air source may include other suitable structure(s) (e.g., alone or in combination with the tube(s)) having outlet(s) configured to output the flow of the second cleaning air (e.g., cleaning air flow).

In the illustrated embodiment, the second cleaning air source 46 includes an air output device 52 disposed within the inlet region 24 of the accumulator 26. The air output device 52 may be mounted to the structure of the accumulator 26 and/or the tube(s) 50 via any suitable type(s) of mount(s) (e.g., strut(s), rod(s), cable(s), etc.). Furthermore, the air output device 52 may include a fan, an air compressor, or another suitable type of air output device. The air output device 52 (e.g., fan, air compressor, etc.) may be driven by any suitable type(s) of drive(s), such as pneumatic motor(s), electric motor(s), hydraulic motor(s), etc. In the illustrated embodiment, the air output device 52 is positioned between the tubes 50. However, in other embodiments, the air output device 52 may be positioned at any suitable location (e.g., within the inlet region of the accumulator, within the storage region of the accumulator, on the chassis of the cotton picker, etc.). In addition, while the second cleaning air source 46 includes a single air output device 52 in the illustrated embodiment, in other embodiments, the second cleaning air source may include additional air output device(s) (e.g., 1, 2, 3, 4, or more additional air output devices).

In certain embodiments, the second cleaning air source 46 is configured to output the flow of the second cleaning air (e.g., cleaning air flow) in pulses. The pulses may enhance the effectiveness of the second cleaning air in inducing turbulent movement of the agricultural material 12 and the debris 32, thereby enhancing separation of the debris 32 from the agricultural material 12. The pulses of the second cleaning air may be output at any suitable frequency (e.g., 0.25 Hz, 0.5 Hz, 1 Hz, 2 Hz, 5 Hz, etc.) and with any suitable duty cycle. While the second cleaning air source 46 outputting the flow of the second cleaning air in pulses is disclosed above, in certain embodiments, the second cleaning air source may be configured to output a continuous flow of the second cleaning air. While the cleaning system 22 includes the second cleaning air source 46 in the illustrated embodiment, in other embodiments, the second cleaning air source may be omitted.

In the illustrated embodiment, the cleaning system 22 includes a third cleaning air source 54 having an outlet 58 disposed between the accumulator 26 and a conveying system 56. The conveying system 56 is configured to convey the agricultural material 12 from the accumulator 26 to the baler. In the illustrated embodiment, the conveying system 56 includes two belts. However, in other embodiments, the conveying system may include more or fewer belts. In addition, the conveying system may include other suitable device(s) (e.g., alone or in combination with the belt(s)) to move the agricultural material to the baler, such as auger(s), etc.

The outlet 58 of the third cleaning air source 54 is directed toward the agricultural material 12 and any remaining debris 32 mixed with the agricultural material 12 flowing between the accumulator 26 and the conveying system 56. The outlet 58 of the third cleaning air source 54 is configured to output a flow of third cleaning air (e.g., cleaning air flow) to direct the debris upwardly (e.g., such that the flows of the first and second cleaning air direct the debris through the grate 34). As a result, the cleanliness of the agricultural material may be further enhanced. Furthermore, the upward flow of the third cleaning air may induce a turbulent roll of the agricultural material 12 at the exit of the accumulator 26, which may drive the agricultural material 12 upwardly before the agricultural material 12 ultimately enters the conveying system 56, thereby enhancing fluidization of the agricultural material 12 at the conveying system 56.

In the illustrated embodiment, the third cleaning air source 54 includes an air output device 60 disposed between the accumulator 26 and the conveying system 56. The air output device 60 may be mounted to the structure of the accumulator 26 and/or the chassis of the cotton picker 10 via any suitable type(s) of mount(s) (e.g., strut(s), rod(s), cable(s), etc.). Furthermore, the air output device 60 may include a fan, an air compressor, or another suitable type of air output device. The air output device 60 (e.g., fan, air compressor, etc.) may be driven by any suitable type(s) of drive(s), such as pneumatic motor(s), electric motor(s), hydraulic motor(s), etc. In addition, while a single outlet is disclosed above, in certain embodiments, the third cleaning air source may include any suitable number of outlets. Furthermore, while the third cleaning air source 54 includes a single air output device 60 in the illustrated embodiment, in other embodiments, the third cleaning air source may include additional air output device(s) (e.g., 1, 2, 3, 4, or more additional air output devices). While the air output device 60 is disposed between the accumulator 26 and the conveying system 56 in the illustrated embodiment, in other embodiments, the air output device may be disposed within/at another suitable location (e.g., within the storage region of the accumulator, on the chassis of the cotton picker, etc.). In addition, while the first cleaning air source 40, the second cleaning air source 46, and the third cleaning air source 54 have separate air output devices in the illustrated embodiment, in other embodiments, at least two of the cleaning air sources (e.g., all of the cleaning air sources) may share a common air output device (e.g., in which air flow from each cleaning air source is controlled by a respective valve assembly).

In certain embodiments, the third cleaning air source 54 is configured to output the flow of the third cleaning air (e.g., cleaning air flow) in pulses. The pulses may enhance the effectiveness of the third cleaning air in separating the debris 32 from the agricultural material 12. The pulses of the third cleaning air may be output at any suitable frequency (e.g., 0.25 Hz, 0.5 Hz, 1 Hz, 2 Hz, 5 Hz, etc.) and with any suitable duty cycle. While the third cleaning air source 54 outputting the flow of the third cleaning air in pulses is disclosed above, in certain embodiments, the third cleaning air source may be configured to output a continuous flow of the third cleaning air. While the cleaning system 22 includes the third cleaning air source 54 in the illustrated embodiment, in other embodiments, the third cleaning air source may be omitted.

In certain embodiments, the cleaning system may include a fourth cleaning air source configured to output fourth cleaning air from an outlet. The outlet may be positioned above the grate at the upper portion of the accumulator, and the outlet may direct the flow of the fourth cleaning air across the grate, thereby substantially reducing or eliminating debris accumulation on the grate. The flow of the fourth cleaning air may also control the direction the debris is expelled from the cotton picker (e.g., based on the location of the outlet), such that the debris is directed/redirected toward a desired location.

In the illustrated embodiment, the cleaning system 22 includes a controller 62 communicatively coupled to the first cleaning air source 40 (e.g., to the air output device 44 of the first cleaning air source 40), to the second cleaning air source 46 (e.g., to the air output device 52 of the second cleaning air source 46), and to the third cleaning air source 54 (e.g., to the air output device 60 of the third cleaning air source 54). In certain embodiments, the controller 62 is an electronic controller having electrical circuitry configured to control the first cleaning air source 40, the second cleaning air source 46, and the third cleaning air source 54. In the illustrated embodiment, the controller 62 includes a processor, such as the illustrated microprocessor 64, and a memory device 66. The controller 62 may also include one or more storage devices and/or other suitable component(s). The processor 64 may be used to execute software, such as software for controlling the first cleaning air source 40, the second cleaning air source 46, and the third cleaning air source 54, and so forth. Moreover, the processor 64 may include multiple microprocessors, one or more “general-purpose” microprocessors, one or more special-purpose microprocessors, and/or one or more application specific integrated circuits (ASICs), or some combination thereof. For example, the processor 64 may include one or more reduced instruction set (RISC) processors.

The memory device 66 may include a volatile memory, such as random access memory (RAM), and/or a nonvolatile memory, such as read-only memory (ROM). The memory device 66 may store a variety of information and may be used for various purposes. For example, the memory device 66 may store processor-executable instructions (e.g., firmware or software) for the processor 64 to execute, such as instructions for controlling the first cleaning air source 40, the second cleaning air source 46, and the third cleaning air source 54, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the first cleaning air source 40, the second cleaning air source 46, and the third cleaning air source 54, etc.), and any other suitable data. The controller may be positioned at any suitable location(s) on the cotton picker (e.g., as one element in one location or as multiple elements in multiple locations).

In the illustrated embodiment, the cleaning system 22 includes a user interface 68 communicatively coupled to the controller 62. The user interface 68 is configured to receive input from an operator and to provide information to the operator. The user interface 68 may include any suitable input device(s) for receiving input, such as a keyboard, a mouse, button(s), switch(es), knob(s), other suitable input device(s), or a combination thereof. In addition, the user interface 68 may include any suitable output device(s) for presenting information to the operator, such as speaker(s), indicator light(s), other suitable output device(s), or a combination thereof. In the illustrated embodiment, the user interface 68 includes a display 70 configured to present visual information to the operator. In certain embodiments, the display 70 may include a touchscreen interface configured to receive input from the operator.

In certain embodiments, the controller 62 is configured to receive a sensor signal indicative of an image of the agricultural material 12 and the debris 32 within the inlet region 24 of the accumulator 26. In certain embodiments, the sensor signal may be received from a camera 72 of the cleaning system 22 communicatively coupled to the controller 62. In the illustrated embodiment, the camera 72 is disposed within the inlet region 24 of the accumulator 26. The camera 72 may be mounted to the structure of the accumulator 26 and/or the structure of the first cleaning air source 40 via any suitable type(s) of mount(s) (e.g., strut(s), rod(s), cable(s), etc.). In certain embodiments, the camera 72 is positioned below the first cleaning air source 40 to block agricultural material 12 and/or debris 32 from accumulating on the camera 72 and/or blocking a field of view of the camera 72. The camera 72 may be directed to any suitable area of the inlet region 24 of the accumulator 26 to enable the camera 72 to capture the image of the agricultural material 12 and the debris 32 within the inlet region 24 of the accumulator 26. While the cleaning system 22 includes a single camera 72 in the illustrated embodiment, in other embodiments, the cleaning system may include multiple cameras, in which each camera is communicatively coupled to the controller and configured to output a respective sensor signal indicative of an image of the agricultural material and the debris within the inlet region of the accumulator. Furthermore, while the camera 72 is disposed within the inlet region 24 of the accumulator 26 in the illustrated embodiment, in other embodiments, the camera may be disposed in another suitable location for capturing the image of the agricultural material and the debris within the inlet region of the accumulator. For example, the camera may be disposed outside of the accumulator, and a window may enable the camera to capture an image of the agricultural material and the debris within the inlet region of the accumulator.

Furthermore, the controller 62 is configured to determine an amount of debris 32 within the inlet region 24 of the accumulator 26 based on the image. The controller 62 may use any suitable image analysis technique(s) to determine the amount of debris 32 within the inlet region 24 of the accumulator 26 based on the image. For example, in certain embodiments, the controller 62 may determine the amount of debris 32 within the inlet region 24 of the accumulator 26 by analyzing the image using an artificial intelligence process, such as machine learning. For example, data corresponding to various images of agricultural material and debris within an inlet region of an accumulator may be used (e.g., by the controller) to train a machine learning process (e.g., stored within the controller). For example, images having various amounts of debris and respective indications of the amounts of debris within the images may be used to train the machine learning process. The controller 62 may then analyze a new image (e.g., from the camera 72) using the machine learning process to determine the amount of debris 32 within the inlet region 24 of the accumulator 26 based on the image. In certain embodiments, the machine learning process may be retrained (e.g., updated) based on operator feedback. For example, after the harvesting process is complete, the operator may input a value corresponding to the amount of debris within the resultant bale (e.g., satisfactory/not satisfactory, values on a scale from 1-5, etc.). The machine learning process may be retrained/updated (e.g., by the controller) based on the images captured during the harvesting process and the value corresponding to the amount of debris within the resultant bale. In embodiments in which multiple cameras capture multiple images, the controller may determine the amount of debris within the inlet region of the accumulator based on the multiple images.

In addition, the controller 62 is configured to control the first cleaning air source 40 (e.g., the air output device 44 of the first cleaning air source 40) based on the amount of debris within the inlet region 24 of the accumulator 26. For example, in response to determining that more debris 32 is present within the inlet region 24 of the accumulator 26, the controller 62 may control the first cleaning air source 40 to increase the flow of the first cleaning air to direct the additional debris through the grate 34. Furthermore, in response to determining that less debris 32 is present within the inlet region 24 of the accumulator 26, the controller 62 may control the first cleaning air source 40 to decrease the flow of the first cleaning air (e.g., including deactivating the first cleaning air source 40) to reduce energy consumption, thereby increasing efficiency of the cotton picker 10.

In certain embodiments, the controller 62 is configured to control the second cleaning air source 46 (e.g., the air output device 52 of the second cleaning air source 46) based on the amount of debris within the inlet region 24 of the accumulator 26. For example, in response to determining that more debris 32 is present within the inlet region 24 of the accumulator 26, the controller 62 may control the second cleaning air source 46 to increase the flow of the second cleaning air to increase the turbulent movement of the agricultural material 12 and the debris 32, thereby enhancing separation of the debris 32 from the agricultural material 12. In embodiments in which the second cleaning air source 46 is configured to output the flow of the second cleaning air in pulses, the controller 62 may control the second cleaning air source 46 to increase the flow of the second cleaning air by increasing the magnitude of each pulse, by increasing the frequency of the pulses, by increasing the duty cycle of the pulses, or a combination thereof. Furthermore, in response to determining that less debris 32 is present within the inlet region 24 of the accumulator 26, the controller 62 may control the second cleaning air source 46 to decrease the flow of the second cleaning air (e.g., including deactivating the second cleaning air source 46) to reduce energy consumption, thereby increasing efficiency of the cotton picker 10. In embodiments in which the second cleaning air source 46 is configured to output the flow of the second cleaning air in pulses, the controller 62 may control the second cleaning air source 46 to decrease the flow of the second cleaning air by decreasing the magnitude of each pulse, by decreasing the frequency of the pulses, by decreasing the duty cycle of the pulses, or a combination thereof.

Furthermore, in certain embodiments, the controller 62 is configured to control the third cleaning air source 54 (e.g., the air output device 60 of the third cleaning air source 54) based on the amount of debris within the inlet region 24 of the accumulator 26. For example, more debris within the inlet region of the accumulator may indicate that more debris is mixed with the agricultural material flowing between the accumulator and the conveyor system. Accordingly, in response to determining that more debris 32 is present within the inlet region 24 of the accumulator 26, the controller 62 may control the third cleaning air source 54 to increase the flow of the third cleaning air to direct the additional debris 32 mixed with the agricultural material 12 upwardly (e.g., into the flows of the first and second cleaning air). In embodiments in which the third cleaning air source 54 is configured to output the flow of the third cleaning air in pulses, the controller 62 may control the third cleaning air source 54 to increase the flow of the third cleaning air by increasing the magnitude of each pulse, by increasing the frequency of the pulses, by increasing the duty cycle of the pulses, or a combination thereof. In addition, in response to determining that less debris is present within the inlet region 24 of the accumulator 26, the controller 62 may control the third cleaning air source 54 to decrease the flow of the third cleaning air (e.g., including deactivating the third cleaning air source 54) to reduce energy consumption, thereby increasing efficiency of the cotton picker 10. In embodiments in which the third cleaning air source 54 is configured to output the flow of the third cleaning air in pulses, the controller 62 may control the third cleaning air source 54 to decrease the flow of the third cleaning air by decreasing the magnitude of each pulse, by decreasing the frequency of the pulses, by decreasing the duty cycle of the pulses, or a combination thereof.

In addition, in certain embodiments, the controller is configured to control the fourth cleaning air source (e.g., an air output device of the fourth cleaning air source) based on the amount of debris within the inlet region of the accumulator. For example, in response to determining that more debris is present within the inlet region of the accumulator, the controller may control the fourth cleaning air source to increase the flow of the fourth cleaning air to direct the additional debris that may pass through the grate away from the grate. Furthermore, in response to determining that less debris is present within the inlet region of the accumulator, the controller may control the fourth cleaning air source to decrease the flow of the fourth cleaning air (e.g., including deactivating the fourth cleaning air source) to reduce energy consumption, thereby increasing efficiency of the cotton picker.

While controlling the cleaning air sources based on the amount of debris within the inlet region of the accumulator is disclosed above, in certain embodiments, the controller may control at least one cleaning air source based on other feedback. For example, in certain embodiments, the controller may activate the fourth cleaning air source in response to initiation of a bale ejection process, in which the bale is ejected from the baler. In such embodiments, the controller may deactivate the fourth cleaning air source in response to termination/completion of the bale ejection process. Furthermore, in certain embodiments, the controller may control at least one cleaning air source (e.g., the first cleaning air source, the second cleaning air source, the third cleaning air source, the fourth cleaning air source, or a combination thereof) based on output of the conveying air source. For example, the controller may be communicatively coupled to the conveying air source and configured to control the conveying air source (e.g., based on an amount of agricultural material being harvested). If the conveying air source is outputting a higher flow rate of the conveying air, the controller may control the first cleaning air source to decrease the flow of the first cleaning air (e.g., because the conveying air flow provides an increased portion of the air flow sufficient to drive the desired amount of debris through the grate), thereby reducing energy consumption. For example, the controller may terminate operation of the first cleaning air source if the conveying air flow is sufficient to remove the desired amount of debris from the agricultural material. In addition, if the conveying air source is outputting a lower flow rate of the conveying air, the controller may control the first cleaning air source to increase the flow of the first cleaning air to direct additional debris through the grate. Additionally or alternatively, the controller may control the second cleaning air source, the third cleaning air source, the fourth cleaning air source, or a combination thereof, based on the output of the conveying air source (e.g., via a positive relationship between the conveying air flow and the cleaning air flow, or via a negative relationship between the conveying air flow and the cleaning air flow). Furthermore, in certain embodiments, the controller may be omitted, and each cleaning air source may be activated during operation of the cotton picker.

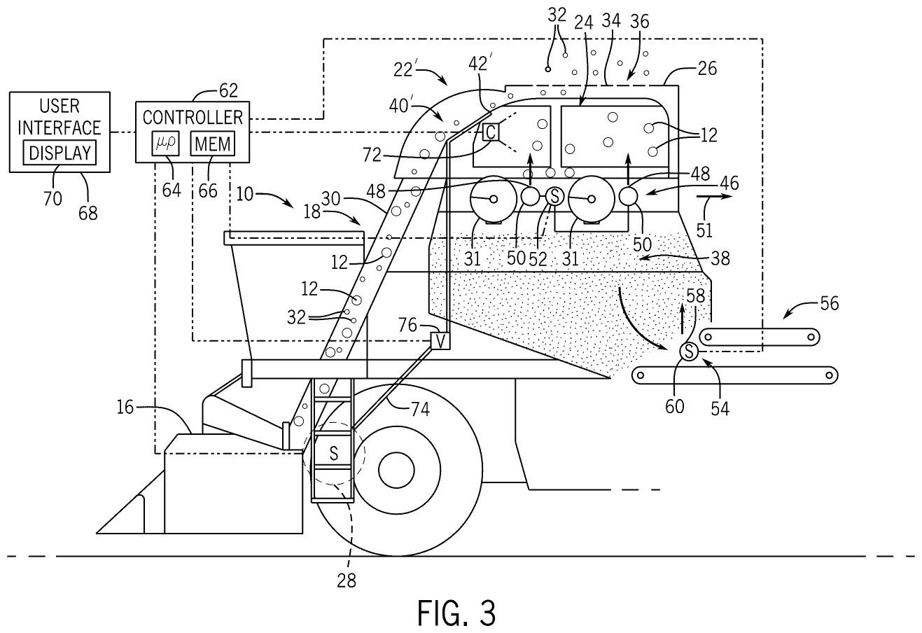

FIG. 3 is a schematic view of another embodiment of a cleaning system 22′ that may be employed within the cotton picker of FIG. 1. In the illustrated embodiment, the cleaning system 22′ includes an alternative first cleaning air source (e.g., cleaning air source) 40′. The first cleaning air source 40′ has an outlet 42′ disposed within the inlet region 24 of the accumulator 26. The outlet 42′ of the first cleaning air source 40′ is separate/distinct from the outlet(s) of the duct(s) 30 of the air-assisted conveying system 18. In addition, the outlet 42′ of the first cleaning air source 40′ is directed toward the grate 34 of the accumulator 26. Accordingly, the first cleaning air source 40′ is configured to output first cleaning air (e.g., cleaning air) toward the agricultural material 12 and the debris 32 within the inlet region 24 of the accumulator 26, thereby driving the agricultural material 12 and the debris 32 toward the grate 34. As a result, the amount of agricultural material 12 and debris 32 directed toward the grate 34 may be increased, as compared to the amount of agricultural material 12 and debris 32 directed toward the grate by the conveying air flow alone. Additionally or alternatively, the speed of the agricultural material 12 and the debris 32 in a direction toward the grate 34 may be increased, as compared to the speed of the agricultural material 12 and the debris 32 in the direction toward the grate 34 caused by the conveying air flow alone. Accordingly, the amount of debris mixed with the agricultural material may be reduced, thereby enhancing the quality/grade of the agricultural material within the resultant bale.

In the illustrated embodiment, the first cleaning air source 40′ includes a conduit 74 extending from the conveying air source 28 to the outlet 42′ of the first cleaning air source 40′. The conduit 74 is configured to receive air from the conveying air source 28 and to direct the air to the outlet 42′, such that the first cleaning air source 40′ outputs the first cleaning air. While the first cleaning air source 40′ includes a single conduit 74 and a single outlet 42′ in the illustrated embodiment, in other embodiments, the first cleaning air source may include additional conduit(s) (e.g., 1, 2, 3, 4, or more additional conduits) and/or additional outlet(s) (e.g., 1, 2, 3, 4, or more additional outlets). For example, the first cleaning air source may include multiple outlets (e.g., each positioned at an end of a respective conduit) distributed along a direction crosswise to the direction of movement of the agricultural material 12 and the debris 32 toward the grate 34.

In certain embodiments, the first cleaning air source 40′ is configured to output a continuous flow of the first cleaning air. Accordingly, the first cleaning air may continuously drive the agricultural material 12 and the debris 32 to move toward the grate 34. However, in certain embodiments, the first cleaning air source may be configured to output the first cleaning air as pulses (e.g., at a high frequency, at a high duty cycle, etc.) to drive the agricultural material and the debris to move toward the grate.

In the illustrated embodiment, the first cleaning air source 40′ includes a valve assembly 76 (e.g., including one or more valves). The valve assembly 76 is disposed along the conduit and configured to control the air flow through the conduit. In embodiments in which the first cleaning air source includes multiple conduits, one valve assembly may be disposed along each conduit, or a single valve assembly may be disposed along all of the conduits.

In certain embodiments, the controller 62 is configured to control the first cleaning air source 40′ (e.g., the valve assembly 76 of the first cleaning air source 40′) based on the amount of debris within the inlet region 24 of the accumulator 26. For example, in response to determining that more debris 32 is present within the inlet region 24 of the accumulator 26, the controller 62 may control the first cleaning air source 40′ to increase the flow of the first cleaning air to direct the additional debris through the grate 34. Furthermore, in response to determining that less debris 32 is present within the inlet region 24 of the accumulator 26, the controller 62 may control the first cleaning air source 40′ to decrease the flow of the first cleaning air to reduce energy consumption, thereby increasing efficiency of the cotton picker 10.

While the embodiment disclosed with reference to FIG. 3 has an alternative first cleaning air source 40′, the remaining elements of the cleaning system 22′ may be the same as the cleaning system 22 disclosed with reference to FIG. 2. Accordingly, each of the functions of the remaining elements of the cleaning system 22′ may be the same as the functions disclosed with reference to FIG. 2. Furthermore, each of the variations of the remaining elements of the cleaning system 22′ may be the same as the variations disclosed with reference to FIG. 2. In addition, the variations associated with control of the first cleaning air source disclosed with reference to FIG. 2 may apply to the first cleaning air source disclosed with reference to FIG. 3. Furthermore, in certain embodiments, at least one of the second cleaning air source, the third cleaning air source, or the fourth cleaning air source may be configured to receive air from the conveying air source (e.g., alone or in combination with the first cleaning air source). In such embodiments, the respective air output device(s) may be omitted, and air flow(s) from the cleaning air source(s) may be controlled by respective valve assembly/assemblies.

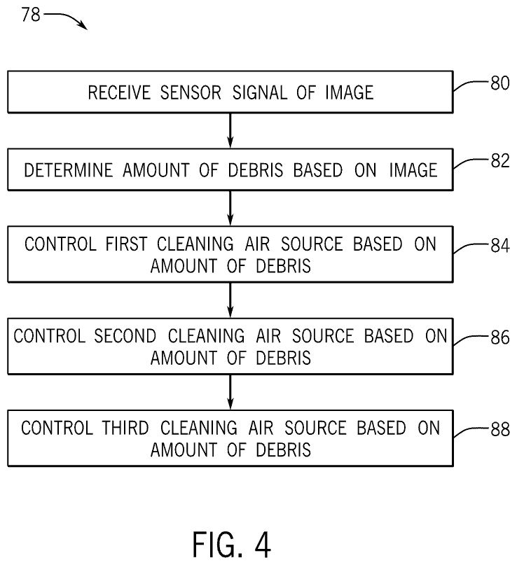

FIG. 4 is a flow diagram of an embodiment of a method 78 for cleaning agricultural material within an accumulator of a cotton picker. The method 78 may be performed by the controller disclosed above with reference to FIGS. 2-3 or any other suitable controller(s). Furthermore, the steps of the method 78 may be performed in the order disclosed herein or in any other suitable order. For example, certain steps of the method may be performed concurrently. In addition, in certain embodiments, at least one of the steps of the method 78 may be omitted.

In the illustrated embodiment, the method 78 includes receiving a sensor signal indicative of an image of the agricultural material and the debris within the inlet region of the accumulator, as represented by block 80. As previously discussed, the sensor signal may be received from a camera disposed within the inlet region of the accumulator. Furthermore, the method 78 includes determining an amount of debris within the inlet region of the accumulator based on the image, as represented by block 82. As previously discussed, determining the amount of debris within the inlet region of the accumulator may include analyzing the image using machine learning. In addition, the method 78 includes controlling the first cleaning air source based on the amount of debris within the inlet region of the accumulator, as represented by block 84. In certain embodiments, the method 78 includes controlling the second cleaning air source based on the amount of debris within the inlet region of the accumulator, as represented by block 86. Furthermore, in certain embodiments, the method 78 includes controlling the third cleaning air source based on the amount of debris within the inlet region of the accumulator, as represented by block 88. The method 78 may be repeatedly performed during operation of the cotton picker.

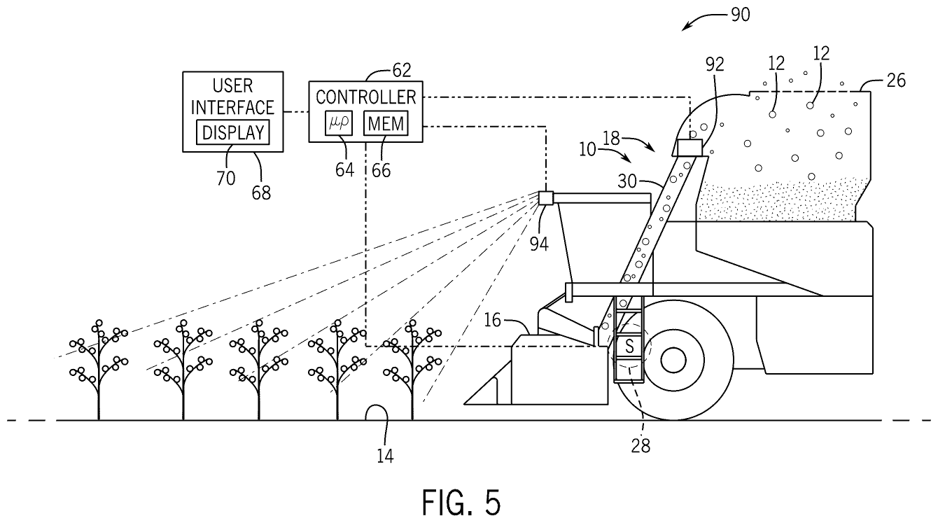

FIG. 5 is a schematic view of an embodiment of a control system 90 that may be employed within the cotton picker of FIG. 1. As previously discussed, the header 16 of the cotton picker 10 includes drums configured to harvest agricultural material 12 (e.g., cotton) from the field 14. Furthermore, the air-assisted conveying system 18 is configured to move the agricultural material 12 from the drums of the header 16 to the accumulator 26. The conveying air source 28 of the air-assisted conveying system 18 is configured to output the conveying air flow through one or more ducts 30. Each duct 30 receives the agricultural material 12 (e.g., cotton) from the header 16, and the conveying air flow output by the conveying air source 28 drives the agricultural material to move through the duct(s) 30 from the header 16 to the accumulator 26.

In the illustrated embodiment, the control system 90 includes the controller 62 and the user interface 68, as disclosed above with reference to FIG. 2. However, in other embodiments, the control system 90 may have another suitable electronic controller. As illustrated, the controller 62 is communicatively coupled to the conveying air source 28. The controller 62 is configured to receive a sensor signal indicative of data associated with harvesting the agricultural material 12, and the controller 62 is configured to determine a flow rate of the agricultural material 12 into the accumulator 26 (e.g., through the duct(s) 30) based at least in part on the data. The controller 62 is also configured to control the conveying air source 28 based on the flow rate. For example, in response to a lower flow rate of the agricultural material 12, the controller 62 may control the conveying air source 28 to decrease the conveying air flow, thereby reducing energy consumption, which increases the efficiency of the cotton picker 10. In addition, in response to a higher flow rate of the agricultural material 12, the controller 62 may control the conveying air source 28 to increase the conveying air flow (e.g., to facilitate debris removal, to substantially reduce or eliminate the possibility of clogging of the duct(s), etc.).

In the illustrated embodiment, the control system 90 includes a yield monitor 92 communicatively coupled to the controller 62. The yield monitor 92 is disposed within one or more ducts 30, and the yield monitor 92 includes one or more sensing plates. For example, one sensing plate of the yield monitor 92 may be disposed within each monitored duct 30. The yield monitor 92 is configured to monitor contact between the agricultural material 92 and each sensing plate. Accordingly, the data includes contact between the agricultural material 12 and the sensing plate(s), and the yield monitor 92 is configured to output the sensor signal indicative of the data. For example, more agricultural material 12 flowing through the duct(s) may cause more frequent contacts between the agricultural material 12 and the sensing plate(s), and less agricultural material flowing through the duct(s) may cause less frequent contacts between the agricultural material 12 and the sensing plate(s). Accordingly, the controller 62 may determine the flow rate of the agricultural material 12 into the accumulator 26 based at least in part on the frequency of contacts between the agricultural material 12 and the sensing plate(s).

In the illustrated embodiment, the control system 90 includes a sensor system 94 communicatively coupled to the controller 62. In certain embodiments, the sensor system 94 includes a camera directed to the field 14 and communicatively coupled to the controller 62. The camera is configured to capture an image of unharvested crops within the field 14. Accordingly, the data includes an image of the unharvested crops within the field, and the camera is configured to output the sensor signal indicative of the data. For example, the camera may be mounted to a cab of the cotton picker 10 and directed toward a region of the field in front of the cotton picker, thereby enabling the camera to capture an image of the unharvested crops within the field 14. The controller 62 is configured to receive the sensor signal from the camera indicative of the data and determine a density of the unharvested crops based on the image. For example, the controller 62 may use any suitable image analysis technique(s) (e.g., including artificial intelligence technique(s), such as machine learning) to determine the density of the unharvested crops based on the image. As used herein, “density” refers to an amount of unharvested crops per area of the field (e.g., including the height of crop stalks, the spacing between the crop stalks, the amount of agricultural material on the crop stalks, other suitable parameter(s), or a combination thereof). After determining the density, the controller 62 may determine the flow rate of the agricultural material into the accumulator based at least in part on the density (e.g., in combination with the width of the header, the speed of the cotton picker 10, other suitable parameter(s), or a combination thereof). While one camera is disclosed above, in certain embodiments, the sensor system may include multiple cameras.

In certain embodiments, the sensor system 94 includes a sonar sensor directed to the field 14 and communicatively coupled to the controller 62. The sonar sensor is configured to monitor a density of the unharvested crops within the field 14. Accordingly, the data includes the density of the unharvested crops within the field, and the sonar sensor is configured to output the sensor signal indicative of the data. For example, the sonar sensor may be mounted to a cab of the cotton picker 10 and directed toward a region of the field in front of the cotton picker. The controller 62 is configured to receive the sensor signal from the sonar sensor indicative of the data and determine the flow rate of the agricultural material into the accumulator based at least in part on the density (e.g., in combination with the width of the header, the speed of the cotton picker 10, other suitable parameter(s), or a combination thereof). While one sonar sensor is disclosed above, in certain embodiments, the sensor system may include multiple sonar sensors.

In certain embodiments, the sensor system 94 includes a radar sensor directed to the field 14 and communicatively coupled to the controller 62. The radar sensor is configured to monitor a density of the unharvested crops within the field 14. Accordingly, the data includes the density of the unharvested crops within the field, and the radar sensor is configured to output the sensor signal indicative of the data. For example, the radar sensor may be mounted to a cab of the cotton picker 10 and directed toward a region of the field in front of the cotton picker. The controller 62 is configured to receive the sensor signal from the radar sensor indicative of the data and determine the flow rate of the agricultural material into the accumulator based at least in part on the density (e.g., in combination with the width of the header, the speed of the cotton picker 10, other suitable parameter(s), or a combination thereof). While one radar sensor is disclosed above, in certain embodiments, the sensor system may include multiple radar sensors.

While a sensor system 94 including camera(s), sonar sensor(s), and radar sensor(s) is disclosed above, in certain embodiments, the sensor system may include a subset of these sensors (e.g., only camera(s), only sonar sensor(s), only radar sensor(s), etc.). Additionally or alternatively, the sensor system may include other suitable sensor(s), such as LIDAR sensor(s), infrared sensor(s), other suitable sensor(s), or a combination thereof. Because the sensor(s) of the sensor system 94 may be directed to the region of the field in front of the cotton picker, the controller may determine the flow rate of particular agricultural material into the accumulator in advance of harvesting the particular agricultural material, thereby providing additional time for the controller to control the conveying air source before the particular agricultural material is harvested.

Furthermore, in certain embodiments, the sensor system may include one or more sensors (e.g., camera(s), sonar sensor(s), radar sensor(s), etc.) directed to a region of the field behind the cotton picker. In such embodiments, the rearward facing sensor(s) may output sensor signal(s) indicative of an amount of residue per area of the field (e.g., the data may include the amount of residue per area of the field). The controller may compare the density of the unharvested crops and the amount of residue per area of the field to determine the amount of agricultural material per area of the field. The controller may then determine the flow rate of the agricultural material into the accumulator based at least in part on the amount of agricultural material per area of the field (e.g., in combination with the width of the header, the speed of the cotton picker, other suitable parameter(s), or a combination thereof). Furthermore, in certain embodiments, the rearward facing sensor(s) may output sensor signal(s) indicative of an amount of agricultural material per area of the field within the region of the field behind the cotton picker (e.g., the data may include the amount of agricultural material per area of the field within the region of the field behind the cotton picker). The controller, after determining the flow rate of the agricultural material into the accumulator based at least in part on feedback from the forward facing sensor(s), as disclosed above, may reduce the determined agricultural material flow rate based at least in part on the amount of agricultural material per area of the field remaining on the field after harvesting, thereby increasing the accuracy of the agricultural material flow rate determination (e.g., while the cotton picker is not harvesting all of the agricultural material from the field).

In certain embodiments, the control system may include a contact sensor configured to monitor contact between the crop stalks and the header. Accordingly, the data includes the contacts between the crop stalks and the header, and the contact sensor is configured to output the sensor signal indicative of the data. The controller 62 is configured to receive the sensor signal from the contact sensor indicative of the data and determine the density of the unharvested crops within the field based on the contacts (e.g., alone or in combination with sensor data indicative of the height of the crop stalks). The controller may then determine the flow rate of the agricultural material into the accumulator based at least in part on the density (e.g., in combination with the width of the header, the speed of the cotton picker 10, other suitable parameter(s), or a combination thereof). In certain embodiments, the controller may use data from multiple sensors (e.g., the yield monitor and at least one sensor of the sensor system) to determine the flow rate of the agricultural material into the accumulator (e.g., using any suitable sensor fusion technique(s)).

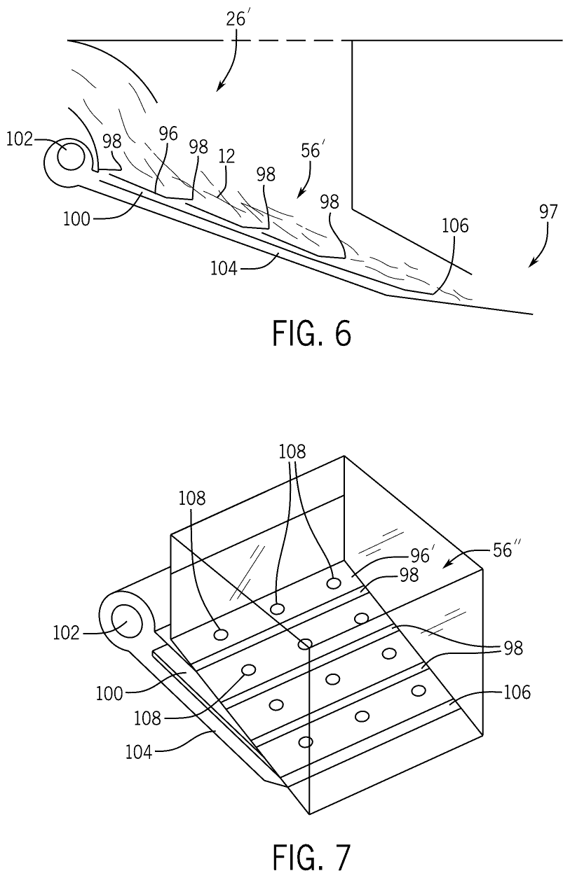

FIG. 6 is a schematic view of an embodiment of a conveying system 56′ that may be employed within the cotton picker of FIG. 1. As previously discussed, the conveying system 56′ is configured to convey the agricultural material 12 (e.g., cotton) to the baler 97. In the illustrated embodiment, the conveying system 56′ includes a platform 96 that forms at least a portion of the floor of the accumulator 26′. The platform 96 is configured to support the agricultural material 12 within the accumulator 26′ and along a path toward the baler 97, such that the platform 96 supports the agricultural material 12 upstream of the baler 97. In the illustrated embodiment, the platform 96 slopes downwardly toward the baler 97 to facilitate movement of the agricultural material 12 toward the baler 97. However, in other embodiments, the platform may be level or may slope upwardly toward the baler.

In the illustrated embodiment, the platform 96 includes multiple outlets 98, and the conveying system 56′ includes a first flow path (e.g., flow path) 100 configured to direct air through the outlets 98 to drive the agricultural material 12 to move along the platform 96 toward the baler 97 (e.g., to the baler 97). Because the conveying system 56′ uses air to move the agricultural material 12 (e.g., cotton) to the baler 97, the cost, complexity, and weight of the conveying system 56′ may be reduced (e.g., as compared to a conveying system that uses moving components, such as rotating belts, augers, etc., to convey the agricultural material to the baler). In the illustrated embodiment, the platform 96 includes four outlets 98. However, in other embodiments, the platform may include more or fewer outlets (e.g., 1, 2, 3, 5, 6, 7, 8, 9, 10, or more). Furthermore, in the illustrated embodiment, each outlet 98 extends along an entire extent of the platform 96 with respect to an axis extending crosswise to a direction of movement of the agricultural material 12 toward the baler 97. However, in other embodiments, at least one outlet may extend along a portion of the extent of the platform with respect to the axis extending crosswise to the direction of movement of the agricultural material toward the baler. In such embodiments, multiple outlets may be spaced apart from one another along the axis extending crosswise to the direction of movement of the agricultural material toward the baler.

In the illustrated embodiment, the conveying system 56′ includes an air output device 102 fluidly coupled to the first flow path 100, and the air output device 102 is configured to output the air to the first flow path 100. The air output device 102 may include a fan, an air compressor, or another suitable type of air output device. The air output device 102 (e.g., fan, air compressor, etc.) may be driven by any suitable type(s) of drive(s), such as pneumatic motor(s), electric motor(s), hydraulic motor(s), etc. While the conveying system 56′ includes a single air output device 102 in the illustrated embodiment, in other embodiments, the conveying system may include multiple air output devices (e.g., 2, 3, 4, or more). Furthermore, while the conveying system 56′ includes air output device(s) 102 in the illustrated embodiment, in other embodiments, the first flow path may be fluidly coupled to another suitable air source/air output device of the cotton picker, such as the conveying air source.

In the illustrated embodiment, the conveying system 56′ includes a second flow path 104 configured to direct the air from the air output device 102 to an opening 106 below the platform 96 to drive the agricultural material 12 to move from the platform 96 to the baler 97. In the illustrated embodiment, the second flow path 104 is positioned below the first flow path 100. In addition, the opening 106 extends along the entire extent of the platform 96 with respect to the axis extending crosswise to the direction of movement of the agricultural material 12 toward the baler 97. However, in other embodiments, the opening may extend along a portion of the extent of the platform with respect to the axis extending crosswise to the direction of movement of the agricultural material toward the baler. In such embodiments, multiple openings may be spaced apart from one another along the axis extending crosswise to the direction of movement of the agricultural material toward the baler. In embodiments in which the air output device is omitted, the second flow path may be fluidly coupled to another suitable air source/air output device of the cotton picker, such as the conveying air source. While the first flow path and the second flow path are fluidly coupled to the same air output device in the illustrated embodiment, in other embodiments, the first flow path may be fluidly coupled to a first air output device, and the second flow path may be fluidly coupled to a second air output device. Furthermore, in certain embodiments, the second flow path and the opening(s) may be omitted.

FIG. 7 is a perspective view of an embodiment of a conveying system 56″ that may be employed within the cotton picker of FIG. 1. In the illustrated embodiment, the platform 96′ slopes downwardly toward the baler to facilitate movement of the agricultural material toward the baler. In addition, the platform 96′ includes multiple outlets 98, and the conveying system 56″ includes the first flow path (e.g., flow path) 100 configured to direct air through the outlets 98 to drive the agricultural material to move along the platform 96′ toward the baler (e.g., to the baler). Furthermore, the conveying system 56″ includes the second flow path 104 configured to direct the air to the opening 106 below the platform 96′ to drive the agricultural material to move from the platform 96′ to the baler 97. The conveying system 56″ also includes the air output device 102 fluidly coupled to the first flow path 100 and the second flow path 104, and the air output device 102 is configured to output the air to the first flow path 100 and to the second flow path 104. However, any of the variations disclosed above with reference to the conveying system 56′ of FIG. 6 may apply to the conveying system 56″ of FIG. 7.

In the illustrated embodiment, the platform 96′ includes multiple nozzles 108 configured to direct the air upwardly to at least partially fluidize the agricultural material. In certain embodiments, the nozzles 108 are fluidly coupled to the first flow path 100, such that the air flows through the first flow path 100 and through the nozzles 108. However, in other embodiments, the nozzles 108 may be configured to receive the air from a secondary air source. In such embodiments, a controller (e.g., the controller 62 disclosed above with reference to FIG. 2 or another suitable electronic controller) may be communicatively coupled to the secondary air source and configured to control the secondary air source to control the air flow through the nozzles 108. For example, the controller may control the secondary air source to establish a continuous flow of air through the nozzles or to establish a pulsing flow of air through the nozzles. In addition, in certain embodiments, the controller may control the secondary air source to provide individual control of the air flow through each nozzle. For example, the controller may control the secondary air source to establish a random pattern of air pulses through the nozzles, to establish a pattern of air pulses along the direction of movement of the agricultural material toward the baler, to establish a pattern of air pulses along a direction crosswise to the direction of movement of the agricultural material toward the baler, etc. The controller may also control the frequency and the pressure of the air pulses. Furthermore, if agricultural material is not provided to a first portion of the platform (e.g., due to certain drums of the header not harvesting agricultural material), the controller may control the secondary air source to pulse the air through the nozzles at a second portion of the platform (e.g., at a higher frequency and/or at a higher duty cycle than the air pulses through the nozzles at the first portion) to redistribute the agricultural material.

In certain embodiments, the conveying system includes a level sensor communicatively coupled to the controller. The level sensor is configured to output a sensor signal indicative of a height of the agricultural material above the platform. The level sensor may include any suitable sensor device(s), such as camera(s), infrared sensor(s), ultrasonic sensor(s), capacitive sensor(s), other suitable sensor device(s), or a combination thereof. The controller may control the secondary air source based on the height of the agricultural material above the platform. For example, in response to the height of the agricultural material decreasing below a threshold height, the controller may activate the secondary air source (e.g., such that a continuous flow of air is output from the nozzles, or such that air is output from the nozzles in pulses). The controller may then deactivate the secondary air source after a period of time (e.g., 1 second, 2 seconds, 3 seconds, 5 seconds, 10 seconds, 15 seconds, etc.). Activating the secondary air source when the height of the agricultural material above the platform is below the threshold height may initiate movement of the agricultural material toward the baler by overcoming the inertia of the agricultural material, thereby substantially reducing the amount of agricultural material that accumulates on the platform.

In certain embodiments, at least a portion of the nozzles 108 are configured to direct the air directly upwardly. Additionally or alternatively, at least a portion of the nozzles 108 are configured to direct the air upwardly and in the direction of movement of the agricultural material toward the baler. In the illustrated embodiment, the nozzles 108 are arranged in three rows with respect to the axis extending crosswise to the direction of movement of the agricultural material toward the baler. The three rows correspond to three ducts of the air-assisted conveying system that provide the agricultural material to the accumulator. However, in certain embodiments, the nozzles may be arranged in more or fewer rows (e.g., based on the number of ducts of the air-assisted conveying system). Furthermore, in certain embodiments, the nozzles may be arranged in another suitable pattern (e.g., random pattern, etc.). While the platform 96′ includes nozzles 108 in the illustrated embodiment, in other embodiments, the nozzles may be omitted. Furthermore, in certain embodiments, the platform 96′ may include the nozzles 108, but the outlets and/or the opening may be omitted. Furthermore, with regard to the embodiments of the conveyor system disclosed with reference to FIGS. 6-7, the accumulator may include a screen (e.g., lateral screen) to facilitate flow of the air output by the outlets, the opening, the nozzles, or a combination thereof, to the environment, while blocking passage of the agricultural material. In addition, with regard to the embodiments of the conveyor system disclosed with reference to FIGS. 6-7, the air output by the outlets and/or the nozzles may facilitate debris removal from the agricultural material (e.g., as disclosed above with reference to FIGS. 1-4).

A cotton picker may include a cleaning system, as disclosed with reference to FIGS. 1-4, a control system, as disclosed with reference to FIG. 5, a conveying system, as disclosed with reference to FIGS. 6-7, or a combination thereof. For example, in certain embodiments, a cotton picker may include only one of the cleaning system, the control system, or the conveying system. Furthermore, in certain embodiments, a cotton picker may include two of the cleaning system, the control system, or the conveying system. In addition, in certain embodiments, the cotton picker may include the cleaning system, the control system, and the conveying system. While the cleaning system, the control system, and the conveying system are disclosed above with reference to a cotton picker, the cleaning system, the control system, and the conveying system may be employed within another suitable agricultural system (e.g., harvester, etc.).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A cleaning system for a cotton picker, comprising:
a cleaning air source having an outlet configured to be disposed within an inlet region of an accumulator of the cotton picker, wherein the outlet of the cleaning air source is configured to be directed toward a grate of the accumulator, the inlet region of the accumulator is configured to receive agricultural material from a header of the cotton picker via a conveying air flow provided by a conveying air source, and the grate is configured to block passage of the agricultural material and to enable passage of debris.

2. The cleaning system of claim 1, wherein the cleaning air source comprises an air output device configured to be disposed within the inlet region of the accumulator.

3. The cleaning system of claim 1, wherein the cleaning air source comprises a conduit configured to extend from the conveying air source to the outlet.

4. The cleaning system of claim 1, wherein the cleaning air source is configured to output a continuous flow of cleaning air.

5. The cleaning system of claim 1, comprising a second cleaning air source having at least one outlet configured to be disposed within the inlet region of the accumulator, wherein the at least one outlet of the second cleaning air source is configured to be directed toward the agricultural material and the debris within the inlet region, and the at least one outlet of the second cleaning air source is configured to output a cleaning air flow to induce turbulent movement of the agricultural material and the debris.

6. The cleaning system of claim 5, wherein the second cleaning air source is configured to output the cleaning air flow in pulses.

7. The cleaning system of claim 5, wherein the second cleaning air source comprises a plurality of tubes configured to extend through the inlet region of the accumulator, and the at least one outlet comprises a plurality of outlets of the plurality of tubes.

8. The cleaning system of claim 1, comprising a third cleaning air source having an outlet configured to be disposed between the accumulator and a conveying system, wherein the outlet of the third air cleaning source is configured to be directed toward the agricultural material and the debris.

9. A control system for a cotton picker, comprising:
a controller comprising a memory and a processor, wherein the controller is configured to:
receive a sensor signal indicative of data associated with harvesting agricultural material;
determine a flow rate of the agricultural material into an accumulator of the cotton picker based at least in part on the data; and
control a conveying air source based on the flow rate, wherein the conveying air source is configured to output a conveying air flow to drive the agricultural material to move through a duct from a header of the cotton picker to the accumulator.

10. The control system of claim 9, comprising a yield monitor disposed within the duct and communicatively coupled to the controller, wherein the data comprises contact between the agricultural material and a sensing plate of the yield monitor, and the yield monitor is configured to output the sensor signal indicative of the data.

11. The control system of claim 9, comprising a camera directed to a field and communicatively coupled to the controller, wherein the data comprises an image of unharvested crops within the field, and the camera is configured to output the sensor signal indicative of the data.

12. The control system of claim 9, comprising a sonar sensor directed to a field and communicatively coupled to the controller, wherein the data comprises a density of unharvested crops within the field, and the sonar sensor is configured to output the sensor signal indicative of the data.

13. The control system of claim 9, comprising a radar sensor directed to a field and communicatively coupled to the controller, wherein the data comprises a density of the unharvested crops within the field, and the radar sensor is configured to output the sensor signal indicative of the data.

14. A conveying system, comprising:
a platform configured to support agricultural material upstream of a baler, wherein the platform comprises a plurality of outlets; and
a flow path configured to direct air through the plurality of outlets to drive the agricultural material to move along the platform toward the baler.

15. The conveying system of claim 14, comprising a second flow path configured to direct the air to an opening below the platform to drive the agricultural material to move from the platform to the baler.

16. The conveying system of claim 14, comprising an air output device fluidly coupled to the flow path and configured to output the air.

17. The conveying system of claim 14, wherein the platform comprises a plurality of nozzles configured to direct the air upwardly to at least partially fluidize the agricultural material.

18. The conveying system of claim 14, wherein the platform slopes downwardly toward the baler.
